(19) United States
(12) Patent Application Publication
(10) Pub. No.: US 2007/0148377 A1
(43) Pub. Date: Jun. 28, 2007

(54) PIGMENT COATED PAPER BASE

(75) Inventor: Jun Naito, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/564,525

(22) Filed: Nov. 29, 2006

Related U.S. Application Data
(63) Continuation of application No. PCT/NL05/00403, filed on Jun. 3, 2005.

(30) Foreign Application Priority Data
Jun. 3, 2004 (EP) 04076658.6

(51) Int. Cl. B41M 5/50

(52) U.S. Cl. 428/32.38

(57) ABSTRACT

The present invention is directed to a pigment coated paper base. Further this invention is directed to a printing paper comprising a pigment coated paper base provided with one or more polymer layers. According to the invention there is provided a pigment coated paper base comprising a paper base and a pigmented coating, in which said paper base is provided with an a combination of an alkyl ketene dimer and an epoxidized fatty acid amide as a sizing agent. The paper base of the present invention is a multipurpose paper base that is suitable for use in a wide range of printing applications.

### RELATED APPLICATIONS

This application is a continuation of PCT application no. PCT/NL2005/000403, designating the United States and filed Jun. 3, 2005; which claims the benefit of the filing date of European application no. EP 04076658.6, filed Jun. 3, 2004; both of which are hereby incorporated herein by reference.

### FIELD

The present invention is directed to a pigment coated paper base. Further this invention is directed to a printing paper comprising a pigment coated paper base provided with one or more polymer layers.

### BACKGROUND

There are many printing applications requiring a printing medium of high quality in order to obtain printed images of photo quality.

In order to achieve such a high quality it is important that the printing media have a high smoothness and a high gloss.

Furthermore the printing media have to fulfil various properties depending on the application used. For example for photographic application, which are those applications in which a silver halide emulsion is coated on a base material, the base material should be water proof, because during developing the emulsion coated substrate is processed in a aqueous developing bath.

Another printing method is the inkjet printing method in which ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, is typically made up of water and organic material such as monohydric alcohols and the like. An image recorded as liquid droplets requires a receptor on which the recording liquid dries quickly without running or spreading. When images are recorded on a recording paper of the plain paper type with an inkjet printer, most portion of the ink laid on the recording paper permeates into its base paper, and so the extent of print-through, the extent of ink running, the optical density of recorded image and the colour reproductivity of ink are influenced by the base paper recipe. When printing ink is ejected to a pigment coated paper base, feathering can occur and/or the water and ink might penetrate the pigmented coating layer and transfer to the cellulose fibers of the paper support, which will results in loss of image sharpness and density.

Another application is a dye sublimation printing process, in which a dye is transferred from a dye carrier by means of heat to a recording medium.

Paper supports for these various applications can conventionally be prepared from a paper base provided with a pigment coated layer. Such a paper support will give good results in the dye sublimation printing process, but in a photographic process the pigment coated paper has to be provided with a polymer resin layer, which is usually a titanium oxide filled polyethylene, polypropylene, a polymethyl-methacrylate resin and the like in order to make it water proof. The application of the polymer resin layer is generally done via a melt extrusion process.

For photographic and ink-jet printing an important aspect of the recording media is the behaviour when in contact with water. In case of using a pigment coated paper base provided with a polymer resin layer in a developing process as used in the silver halide photographic process, developing liquid might enter through the edges into the cellulose fibers giving coloured edges. This phenomenon is known as edge penetration.

In the prior art related to silver halide photographic printing, entering of the developer solution is prevented through the use of sizing agents alkyl ketene dimer (AKD) and/or epoxidized fatty acid amides (EFA) in the paper manufacturing process (U.S. Pat. No. 4,808,267, U.S. Pat. No. 6,362,614, U.S. Pat. No. 6,474,856). The use of AKD as a sizing agent has the disadvantage that it is responsible in the production process for stains on rolls such as press rolls and tends to render the raw paper surfaces slippery. Furthermore, it was found, that the solutions of the prior art in order to improve the behaviour of printing media when in contact with water are insufficient, when printing media are used in which on top of the cellulose fibers a pigmented coating is applied.

### SUMMARY

It is an object of the present invention, to provide a multipurpose pigment coated paper base that is suitable for use in a wide range of printing applications.

It is a further object of this invention to provide a pigment coated paper base with a high smoothness and high gloss, which when printed gives images of photo quality.

It is still a further object of the present invention to provide a pigment coated paper base, which gives sharp and high density images when used for inkjet printing.

It is another object of the present invention to provide a pigment coated paper base provided with a polymer resin layer having good smoothness and a high gloss.

It is also an object of this invention to provide a pigment coated paper base provided with a polymer resin, which show almost no edge penetration when processed in aqueous solutions.

These and other objects of the invention are achieved through a pigment coated paper base comprising a paper base and a pigmented coating in which said paper base is provided with an epoxydised fatty acid amide and an alkyl ketene dimer as sizing agents. This pigment coated paper base can be used as such for certain printing applications or used after a polymer resin matrix is applied to said pigment coated paper base.

### DETAILED DESCRIPTION

According to the present invention there is provided a pigment coated paper base comprising a paper base and a pigmented coating in which said paper base is provided with an epoxydised fatty acid amide (EFA) and an alkyl ketene dimer (AKD) as sizing agents. This pigment coated paper base can be used as such or used after being provided with a polymer resin matrix.

In our search for high quality, multipurpose recording media (viz. media that can be used universally in different kinds of printing applications) we came across the problem that a paper suitable for dye sublimation applications is generally not suitable for use in a silver halide printing process. This is because in the dye sublimation process there is almost no wetting of the recording medium, while in the silver halide photo process the recording medium provided with a silver halide emulsion is totally immersed in an aqueous solutions during the development process (see for example US-A-2002/0 001 783). From wetability point of view the inkjet printing process is in between the dye sublimation process and the silver halide photo process. In the inkjet printing process the ink droplets, generally comprising a relatively large amount of solvent in order to prevent clogging of the nozzle are ejected onto a recording medium for example pigment coated paper base. The liquid of the ink droplet penetrates trough the pigment coating layer and tends to diffuse through the cellulose fibers, causing unsharp and low density images.

Although the various printing applications might require printing media having distinguishable compositions, it is for a paper base manufacturer very efficient to produce one base material, which can be used in all these different imaging processes in one manufacturing step without the need to start or stop the manufacturing process or to adjust the recipes in the manufacturing process. A prerequisite is of course, that the base material should have a high quality with respect to physical properties and that the raw material price should be low. One of the important properties is the smoothness and the gloss of the printing medium. Although a rather smooth paper surface can be obtained by calendering or supercalendering a non pigment coated paper base, the best way to obtain a smooth and glossy surface is to use a pigment coating at least on the top side surface of the paper base and optionally calendering the coated material afterwards. In case waterproof paper is required a polymer resin can be applied on both top and back side of the pigment coated paper base. It was found, that at the cut edge of the pigment coated paper base provided with a polymer resin, the edge penetration was at an unacceptable level and much worse than when compared to paper base provided with a polymer matrix, which paper base has no pigmented coating layer between paper base and polymer resin. Without wishing to be bound by theory, one explanation for the worse edge penetration can be, that the pigmented coating layer might stimulate the liquid penetration at the cut edge through microporous hydrophilic channels in the pigmented layer. A countermeasure can be to make the cellulose fibers more hydrophobic. In the prior art the use of AKD is extensively described as an agent for making the cellulose fibers more hydrophobic (see for example U.S. Pat. No. 4,820,582). It has also been described, that this AKD tends to migrate to the paper surface and by this causing stain formation in the manufacturing process. Therefore there is a maximum on the amount of AKD which can be used without the passrollers getting stained by the AKD which is leaked out of the paper. The amount of AKD which has to be added to achieve the same edge penetration for a pigment coated paper base provided with a polymer resin as for the not pigment coated type is beyond the acceptable limit.

We have found, that incorporation of an epoxydised fatty acid amide (EFA) in combination with AKD in the paper base as a sizing agent does not show the disadvantages of the prior art. Furthermore, we found, that by incorporating EFA as a sizing agent, the amount of AKD can be reduced to such an extent, that leaking out of the AKD to the paper surface is not a problem anymore.

Epoxidized fatty acid amides used in the present invention are added during the paper making process together with the AKD. The EFA's function as a sizing agent. Specific examples thereof include the condensation products of fatty acids and polyamines as disclosed, e.g., in JP-B-38-20601 (the term “JP-B” as used herein means an “examined Japanese patent publication”), JP-B-39-4507, U.S. Pat. No. 3,692,092, and the reaction products of alkenyl succinic acids and polyamines as disclosed in JP-A-51-1705 (the term “JP-A” as used herein means an “unexamined published Japanese patent application). Of the fatty acids as cited above, those preferred in the present invention are aliphatic mono- and polycarboxylic acids containing 8 to 30, especially 12 to 25, carbon atoms. Specific examples of such aliphatic carboxylic acids include stearic acid, oleic acid, lauric acid, palmitic acid, arachic acid, behenic acid, tall oil fatty acid, alkylsuccinic acid, alkenyl succinic acid, and so on. In particular, behenic acid is favored over others. As for the polyamines, polyalkylenepolyamines, especially those having two or three amino groups, are preferable.

Specific examples of such polyamines include diethylenetriamine, triethylenetetramine, tetraethylenepentamine, pentaethylenehexamine, dipropylenetriamine, tripropylenetetramine, aminoethylethanolamine, and so on. In order to render the reaction products of aliphatic carboxylic acids with polyamines soluble or dispersible in water, it is preferred to convert them into salts by making them react with an inorganic or organic acid or to modify them using an alkyl halide, benzyl chloride, ethylene chlorohydrin, epichlorohydrin, ethylene oxide or the like so as to have the form of quaternary salt. In particular, it is favored to convert them into quaternary salt via the reaction with epichlorohydrin, because the resulting salts can provide a great sizing effect. The epoxidized higher fatty acid amides are added in a proper amount, provided that the proportion thereof to the bone dry pulp is not greater than 2.0% by weight, preferably within the range of 0.1 to 2.0% by weight and more preferably from 0.1 to 1% by weight.

As indicated above the use of an alkyl ketene dimer as a sizing agent has certain drawbacks. We now have surprisingly found, that the use of an AKD together with an EFA gives a multipurpose paper having a very good behaviour towards edge penetration.

In practice alkyl ketene dimers of differing lengths of alkyl chains can be used (“mixed” alkyl ketene dimers). The alkyl residues therein may contain between 12 and 18 carbon atoms as is illustrated e.g. in Research Disclosure, November 1978, report 17516. Alkyl ketene dimers of between 16 and 18 carbon atoms alkyl residues are commonly used. Also the alkyl ketene dimers derived from fatty acids containing 8 to 30 carbon atoms are very suitable and also those described in U.S. Pat. No. 4,820,582. In particular, the alkyl ketene dimer derived from behenic acid is used to advantage. A suitable proportion of the alkyl ketene dimer is in the range of 0.05 to 2.0% by weight, preferably from 0.1 to 1.5% by weight, and more preferably from 0.1 to 1% by weight based on bone dry pulp.

The most preferred EFA/AKD ratio is from 10/90 to 60/40. From the data with respect to edge penetration, we can conclude, that there is an unexpected synergetic effect when using both AKD and EFA as sizing agents. Using the above-mentioned ratios, the amounts of both EFA and AKD can be used below 1% based on bone-dry pulp, while the edge penetration behavior remains very good.

In accordance with the present invention the combination of EFA/AKD sizing agents can be applied to the raw paper by both internal or external sizing methods, both known per se in the art.

During the paper manufacturing apart from the epoxydised fatty acid amides and AKD of the present invention, materials conventionally used in paper base manufacturing are used. Generally the paper is based on natural wood pulp and if desired a filler such as talc, calcium carbonate, TiO₂, BaSO₄ and the like. Generally the paper base also contains colouring agents such as dyes, optical brighteners and the like. Further the paper substrate may contain a reinforcing agent like polyacrylamide or starch. Further additives in the paper substrate can be fixing agents, such as aluminium sulphate, cationic polymers and the like. In order to get an especially good paper base usually short fibers are used in the natural pulp. The raw paper substrate made as described above may be impregnated or coated with a solution containing various water-soluble additives by means of a size press, a tub size, a gate roll coater or the like. Specific examples of water-soluble additives include high molecular compounds such as starch, polyvinyl alcohol, carboxy-modified polyvinyl alcohol, carboxymethyl cellulose, hydroxyethyl cellulose, sodium alginate, cellulose sulphate, gelatin, casein, etc., and metal salts such as calcium chloride, sodium chloride, sodium sulphate, etc.

To the solution containing water-soluble additives as cited above, there may be further added a hygroscopic compound such as glycerol, polyethylene glycol or the like, a colouring or brightening material such as dyes, an optical whitening agent or the like, and a pH controlling agent such as sodium hydroxide, aqueous ammonia, hydrochloric acid, sulphuric acid, sodium carbonate, etc. In addition, pigments may be added to the foregoing solution, if needed. This impregnating of the raw paper substrate is called surface sizing as is well known to those in the art.

The raw paper base is not particularly restricted in its species and thickness. However, it is generally desired that the base has a weight ranging from 50 to 300 g/m².

The paper base is prepared from the above components in a conventional way using known machinery. After the cellulose fibers in their formulation are applied to a dewatering web they are dried to form a paper sheet which is wound on big rolls.

To the paper base as described above a pigmented coating layer is applied to obtain the pigment coated paper base. This pigmented coating comprises or is based on a liquid, in particular water optionally in combination with other liquids, one or more pigments, one or more binders and other components suitable for preparing a stable pigment dispersion suitable for application onto a paper base.

The pigment can suitably be selected from kaolin, clay, titanium dioxide, calcium sulphate, barium sulphate, satin white, synthetic silica, China clay, magnesium carbonate, alumina, talc, illite, delaminated clay, ground calcium carbonate, precipitated calcium carbonate, zinc oxide, silicic acid, silicate, colloidal silica other metal oxides or salts and the like, as well as organic pigments such as plastic pigment. These pigments can be used alone or in combination.

The binder can be selected from polyvinyl alcohol, starch including oxidized starch, esterified starch, enzymatically denatured starch, cationized starch and so on, casein, soybean protein, dextrin, cellulose derivatives including carboxy-methyl cellulose, hydroxyethyl cellulose and the like, a styrene-acrylic resin, an isobutylene-maleic anhydride resin, an acrylic emulsion, a vinyl acetate emulsion, a vinylidene chloride emulsion, a polyester emulsion, a styrene-butadiene latex, methyl methacrylate butadiene latex, polyacrylate latex, an acrylnitrile-butadiene latex and the like. These binders can be used alone or as a mixture of two or more thereof.

The pigment coating compositions will also generally contain from 0.02% to 1% by weight, based on the weight of the pigment, of a dispersing agent for the inorganic pigment. If desired, a surface sizing agent, an anti-foaming agent, a pH adjuster and other conventional additives, may also be added to the coating solution for the pigment coatings, insofar as the effects of the present invention are not marred by the addition thereof.

It is preferred that the pigment coating is hydrophilic. An aqueous pigmented coating dispersion can be applied in various ways, by which a hydrophilic coating may be obtained in accordance with the present invention.

One way is to apply the pigment coating during the paper making process after the dewatering step. This coating can be applied in a way familiar to those known in the art after which the paper is dried further before the winding in the paper machine.

The pigmented dispersion can also be applied after the paper has been wound on rolls, by unwinding the roll and apply the pigmented coating, drying and winding again. The aqueous pigmented coating is applied at temperatures below 100° C., preferably above 20° C. and below 80° C. Also a combination of both methods can be used.

The application of the coating can be done using conventional methods like double-roll size-press coater or gate-roll coater, blade-metering size-press coater or rod-metering size-press coater, sym-sizer or other film-transfer roll coater, flooded-nip/blade coater, jet-fountain/blade coater and short-dowel time-application coater, a rod-metering coater using grooved rods or plain rods instead of blades, curtain coater, die coater or any other known coater may also be used.

The total amount of pigment or pigment mixture to be used is not particularly limited. Good results are obtained with pigmented coating amounts from 0.5 to 40 g/m², preferably the amount is between 1 and 30 g/m². The particle size of the pigment is in principle not restricted, but the average particle size is preferably below 2 μm and more preferably below 1 μm, in order to obtain the best surface characteristics.

Calendering of the paper is very beneficial to obtain a smooth and glossy surface. Calendering can be done at various stages during the manufacturing of the pigment coated paper base. It can be done for example before the application of the pigment coating or after the application of the pigmented coating. In all cases it is possible to obtain a pigment coated paper base with a surface roughness R_{A} below 1 μm. The surface roughness parameter is commonly used and known to those skilled in the art. Surface roughness parameter is suitably measured using UBM equipment with the following settings:

(1) Point density 500 P/mm

(2) Area 5.6×4.0 mm

(3) Cut-off wavelength 0.80 mm

(4) Speed 0.5 mm/sec.

according to DIN 4776; software package version 1.62.

Preferably, the surface roughness parameter R_{A} is below 1 μm. The more preferred surface roughness is less than 0.8 μm. If one wants to have a very smooth and high gloss pigment coated paper base material a surface roughness below 0.5 μm might be advantageous. This low surface roughness can be obtained by (super) calendering. In the calendering step during paper making, the paper is pressed between rollers. By this the space between the fibers gets less, by which a smoother surface results. This has as a disadvantage, that the thickness and stiffness of the paper is negatively influenced if the pressure of the calender rolls is increased too much. When using low grade paper base the thickness and stiffness qualities may become below an acceptable level using super calendering. However it is possible to obtain these values for the surface roughness, namely in case a good quality paper base with sufficient bulk paper density is pigment coated according to the present invention. With these type of papers the thickness and stiffness quality remain-within acceptable levels even with high level calendering, resulting in very low surface roughness values R_{A} of 0.5 μm or less. Using the technique of the present invention it is possible to use a variety of paper qualities and upgrade these by the method described above.

The pigment coated paper base as described above is very suitable for use in printing applications like Giclee printing, colour copying, screen printing, xerography, gravure, dye-sublimation, flexography or inkjet. Compared to the prior art this paper shows in inkjet application no feathering, while a sharp and high density image is obtained.

For photographic applications the above described pigmented paper base still has to be coated on the top side and the back side with a polymer resin. The application of the polymer resin on top and back side is conventionally done using a melt extrusion coating (MEC) technique. In a preferred embodiment a co extrusion technique is used in which polymer layers of various composition can be coated simultaneously on the pigment coated paper base. This process is conventionally performed at line speeds over 200 m/min and preferably over 300 m/min. At such high line speeds crater defects, pinholes easily occur in the top side resin layer, which results in a matte-like appearance.

In EP-A-0 952 483 it has been described, that a surface roughness R_{A} of a pigment coated paper base below 1 μm is required to prevent the occurrence of crater defects during the melt extrusion coating. As expected the pigmented coated paper base according to the present invention gives almost no crater defects upon extrusion coating, while a very high smoothness and gloss is obtained. The MEC is performed by applying thin layers of polymers simultaneously at high temperatures from 280 to 340° C. using high line speeds from over 200 m/min and preferably over 300 m/min. The layers at the topside can be applied by stepwise extrusion of single polymer layers or preferably in a co-extrusion MEC system. If necessary, the top surface, and also the back surface of the pigment coated paper base is subjected to an activation treatment before and/or after the MEC. The treatment may comprise a corona treatment and/or a flame treatment and/or ozone treatment and/or plasma treatment or combinations of these treatments.

The polymer resin can be selected from high-density polyethylene, medium density polyethylene and low-density polyethylene, polypropylene, polybutene, polystyrene, polyvinyl chloride, polyvinylidene chloride, polycarbonate, polyethylene terephthalate, polyamide and polyacrylate resins, polymethyl-methacrylate and the like, co-polymers of two or more olefins such as ethylene-propylene co-polymer, ethylene butylene co-polymer, ethylene octene copolymer and mixtures thereof. These polymers have no particular limitations on molecular weight, provided that the resin coating formed by an extrusion coating method can retain therein a white pigment and a coloured pigment or a brightening agent. In general, however, resins having their molecular weight in the range of 20 000 to 200 000 are used. Particular preferable polyolefins are high-density polyethylene, medium density polyethylene and low-density polyethylene and mixtures thereof. In case the resin layer is of the multi-layer type, resins in each layer may differ from each other in chemical structure and/or in physical properties such as melt indexes.

The polymer resin layer will generally contain additives such as white pigments (metal-oxide), dyes, coloured pigments, adhesion promoters, optical brighteners, stabilizing agent such as bisphenol, thiobisphenol, amines, benzophenone, salicylates, benzotriazole and organometallic compounds and the like. The polymer resin layer on the top side will preferably contain a white pigment and a coloured pigment or dyes.

The pigments for the polymer resin layer can be selected from the group consisting of kaolin, clay, titanium dioxide, calcium sulphate, barium sulphate, satin white synthetic silica, China clay, magnesium carbonate, alumina, talc, illite, delaminated clay, ground calcium carbonate, precipitated calcium carbonate, zinc oxide, silicic acid, silicate, colloidal silica other metal oxides or salts and the like and combinations thereof.

The polyolefin resin coats don't have any particular restriction as to the coated amount/m2 or to thickness.

A polymer resin weight up to 60 g/m2 (for professional paper grade) can be used, but preferred resin ranges depend on the usage for specific market products (like professional-, consumer markets). Conventionally the resin weight varies between 30 and 35 g/m², whereas there are applications like for consumer products, where an amount of lower than 30, or even 15 to 25 g/m² may be used for the top side resin. Because of the use of the pigment coated paper base during MEC the amount of applied polymer can be reduced when compared to conventional not pigment coated paper base and still obtain a smoother and glossier product. In order to obtain a good behavior with respect to curling the back side polymer resin layer should be adjusted accordingly and may comprise a resin amount from 10-60 g/m².

The thickness of the polymer resin layer is mainly determined by the amount of polymer resin applied and is generally in the range of 10 to 60 μm.

It is also possible to omit the back side polymer resin coating and to use other means for curl compensation by applying for example a gelatin coating. Although this printing paper only on the top side provided with a polymer resin is very suitably for many printing applications where a high quality print is required, it is evident, that this paper is not suitable in a photographic process as developer solution can freely penetrate through the back side (even EFA and AKD being present), staining the obtained image.

The polymer resin coat can be applied on the pigment coated paper base using ordinary extruders and laminators for polyolefins.

The total thickness of the pigment coated paper base on which the polymer resin is applied (it is the printing paper) may vary between 60 and 360 μm.

The printing paper is very suitable as a base in all kind of printing applications like Giclee printing, colour copying, xerography, screen printing, gravure, dye-sublimation, flexography, inkjet and photography. First of all when provided with a silver halide emulsion, it is very suitable to be used in the photographic printing process. When provide with a swellable layer mainly composed of gelatin and other water soluble polymers, it is very suitable to be used in inkjet or dye sublimation application. When it is provided with a micro porous layer it is very suitable for inkjet and dye sublimation applications and so on.

The invention is also directed to a method for producing a pigment coated paper base as described herein above, comprising providing a paper base having a topside and a backside with an EFA/AKD mixture as sizing agent, applying an aqueous pigmented coating dispersion on said topside of said paper substrate drying this and calendering it, to give a pigment coated paper base and to a method for the manufacturing a printing paper by applying on the top and optionally on the back side of said pigment coated paper base a polymer resin layer using MEC. The pigmented coating thus obtained is typically hydrophilic.

Further the invention is also directed to a photographic paper comprising said printing paper and a photographic emulsion applied on said printing paper and to an inkjet paper comprising said printing paper and an ink receiving layer applied to said printing paper.

Furthermore the invention is directed to the use of said photographic paper and inkjet paper in their respective application.

The invention is now further elucidated on the basis of the following examples.

### EXAMPLES

Paper Base Preparation

A high quality paper substrate, comprising 100% hardwood kraft bleached pulp, basis weight 150 g/m², thickness 150 μm and a starch based internal sizing agent which contains optical brightener, was used. The internal sized paper substrate was pre-calendered such that the bulk density and therefore in particular the surface density was increased. The surface was smoothened in order to close the pores at the surface preventing penetration of the sizing solution too deeply inside the paper bulk. Subsequently, this was treated with a thermally modified non-ionic starch. The starch was dissolved in a 1.8% (w/v) aqueous NaCl solution. After applying the unpigmented starch solution as a surface sizing and drying, the paper substrate was finish-calendered until a bulk density ranging between 0.95-1.00 g/cm² and a surface roughness R_{A} of 1.2 μm was achieved.

Experiment 1

The same procedure as described above was followed for the paper base making except that now EFA, AKD or EFA/AKD mixtures were used as internal sizing agent and a pigmented coating was applied on the wire-side of the paper for inventive Example 1-5 and Comparison 1-5, with a coating weight of 20 g/m², using calcium carbonate (85% 1-2 μm average diameter and 15 wt. % of CaCO₃<1.0 μm average diameter) as pigment. On 100 parts by weight of CaCO₃, 25 parts by weight of styrene-acrylate latex were used as binder.

After calendering the paper had an average surface roughness of 0.8 μm.

The EFA used was a condensation product of behenic acid, diethylene-triamine/triethylenetetramine and epichlorohydrin.

The AKD used was an AKD derived form behenic acid.

The composition of the various samples is given in Table 1.

TABLE 1

| | Example (Invention) | | | | | Comparison | | | | | | |
|---|---|---|---|---|---|---|---|---|---|---|---|---|
| | 1 | 2 | 3 | 4 | 5 | 1 | 2 | 3 | 4 | 5 | 6 | 7 |
| | Coated | | | | | Coated | | | | | Uncoated | |
| AKD¹⁾ | 0.2 | 0.3 | 0.4 | 0.45 | 0.4 | 0.5 | 0 | 0.1 | 0.6 | 0.7 | 0.5 | 0.3 |
| EFA¹⁾ | 0.3 | 0.2 | 0.1 | 0.05 | 0.2 | 0 | 0.5 | 0.4 | 0 | 0 | 0 | 0.2 |
| Ratio²⁾ | 60 | 40 | 20 | 10 | 33 | 0 | 100 | 80 | 0 | 0 | 0 | 40 |
| Sum³⁾ | 0.5 | 0.5 | 0.5 | 0.5 | 0.6 | 0.5 | 0.5 | 0.5 | 0.6 | 0.7 | 0.5 | 0.5 |

¹⁾wt % on dry pulp base
²⁾100 × EFA [wt. %]/(EFA [wt. %] + AKD [wt. %])
³⁾AKD [wt. %] + EFA [wt. %]

Before applying the pigment coating on the paper base, the base was first inspected by SEM pictures on the presence of AKD on the surface, caused by AKD migration.

The extent of AKD migration was judged as follows:

O: almost no AKD on the surface.

Δ: AKD on the surface can be observed.

X: Easy to observe AKD on the surface.

The results are shown in Table 2.

In the table, AKD/EFA migration is listed, this is done for the sake of completeness, as EFA does not migrate to the surface or only in a very limited amount.

The samples from Inventive Example 1-5 and Comparison 1-7 were inkjet printed with a standard image comprising black, cyan, magenta and yellow bars. The image contained also two pictures; including a portrait picture and a composition picture. The image was printed at a room conditions (23° C. and 48% Relative Humidity (RH)) and the printed materials were kept at this condition for at least 1 hour to dry.

A HP Deskjet® 5650 was used to print the images by using the following settings:
Print quality: best
Selected Paper type: HP premium plus photo paper, glossy
Other parameters were according to the factory setting.

The quality of the printed images were further analysed visually by analysing the sharpness and the feathering.

The sharpness was judged as follows:

O: Sharp picture

Δ: Some unsharpness

X: Unsharp

The feathering was judged as follows:

O: No feathering

Δ: Sometimes feathering observed

X: Regular occurrence of feathering

The results are summarized in Table 2

TABLE 2

| | sample | | | | | Comparison | | | | | | |
|---|---|---|---|---|---|---|---|---|---|---|---|---|
| | 1 | 2 | 3 | 4 | 5 | 1 | 2 | 3 | 4 | 5 | 6 | 7 |
| Sharpness | ◯ | ◯ | ◯ | ◯ | ◯ | Δ | x | x | ◯ | ◯ | x | x |
| Feathering | ◯ | ◯ | ◯ | ◯ | ◯ | Δ | x | x | ◯ | ◯ | ◯ | ◯ |
| AKD/EFA | ◯ | ◯ | Δ | Δ | Δ | x | ◯ | ◯ | x | x | x | ◯ |
| migration | | | | | | | | | | | | |

From the results of Table 2 it follows that the AKD amount should be preferably below 0.5% by weight in order to prevent unacceptable AKD migration results.

Furthermore it is evident that at proper amounts of EFA and AKD and at proper EFA/AKD ratio's we can obtain sharp images without feathering. The big advantage of the use of EFA is that it does not show any soiling and the use amount of AKD can be reduced to below 0.5% by weight.

To be effective the EFA/AKD ratio should be between 10/90 and 60/40.

Experiment 2

Example 1-5 (in accordance with the invention) and Comparison 1-7 of Experiment 1 were melt co-extrusion coated at the side of the pigmented coating with the following structure. Outermost layer (image side), 1 g/m², containing a LDPE/LLDPE with ratio of 50/50, second layer, 12.5 g/m2, containing LDPE, 25% anatase TiO₂ pigment, ultramarine blue and ultramarine violet, quinacridone and bis-benzoxale substituted stilbene type optical brightener and third, nearest layer to the pigmented coated paper, 16.5 g/m², containing LDPE, 5% anatase TiO₂ pigment, ultramarine blue and ultramarine violet and quinacridone a line speed of 350 m/min to give the samples L1-L5 and comparison samples L1-L7. The melt temperature is 320° C. with a nip roll pressure of 4.0 N/m² at a glossy cooling roll. The backside of the paper substrate is extrusion coated with a LDPE/HDPE ratio of 50/50 with an amount of 20 g/m². Before the polyethylene layers are extruded, the paper surface is first activated by Corona treatment in order to improve the adhesion between the paper surface and the polyethylene melt.

Evaluation of the Edge Penetration

Sample: resin coated paper. Sample size: 14 cm (machine direction)×3.5 cm(Cross direction)

chemicals: CP40FAII(colour-developer, bleach-fix)

Inventive Examples L1-L5 and comparisons L1-L7 were immersed according to the following sequence:
colour-developer at 45C (16 min.)
bleach-fix at room temperature (1 min.)
water at 38C (1 min.)

After this dipping sequence the samples were dried. After the dipping test, the penetrated area was calculated by image analysis and described as % penetration: (no penetration=0%; full penetration=100%).

The edge penetration after the dipping was judged as follows:

O: Less than 20% penetration

Δ: Penetration between 20 and 40%

X: Penetration over 40%

The results of the dipping together with the AKD migration results are shown in Table 3.

TABLE 3

| | |
|---|---|
| Example (Invention) | Comparison |

| | L1 | L2 | L3 | L4 | L5 | L1 | L2 | L3 | L4 | L5 | L6 | L7 |
|---|---|---|---|---|---|---|---|---|---|---|---|---|
| edge | ◯ | ◯ | ◯ | ◯ | ◯ | Δ | X | Δ | ◯ | ◯ | ◯ | ◯ |
| penetration | | | | | | | | | | | | |
| AKD/EFA | ◯ | ◯ | Δ | Δ | Δ | X | ◯ | ◯ | X | X | X | ◯ |
| migration | | | | | | | | | | | | |

An edge penetration over 20% is in fact not acceptable any more, so therefore comparison L3 is not preferred. Although inventive Examples L3-L5 show AKD on the paper surface, using these recipes gave no problem in the manufacturing process. Comparison L7 gives good results both on edge penetration and AKD migration. However L7 is manufactured with a non pigment coated paper base and does not show an acceptable behaviour with respect to gloss and smoothness. When comparing comparison L1 and L6 clearly the negative influence of the applied pigment coating on the edge penetration can be observed.

1. A pigment coated paper base comprising a paper base and a water-based pigmented coating, in which said paper base is provided with a combination of an alkyl ketene dimer and an epoxidized fatty acid amide as a sizing agent.

2. The pigment coated paper base according to claim 1, wherein said water-based pigmented coating is hydrophilic.

3. The pigment coated paper base according to claim 1, wherein the ratio of epoxidized fatty acid amide/alkyl ketene dimer is from 10/90 to 60/40.

4. The pigment coated paper base according to claim 1, wherein the average surface roughness R_{A} is less than 1.0 μm.

5. The pigment coated paper base according to claim 1, wherein the paper base has a weight from 50 to 300 g/m².

6. The pigment coated paper base according to claim 1, wherein the pigmented coating comprises a pigment and a binder.

7. The pigment coated paper base according to claim 6, wherein the pigment is selected from the group consisting of CaCO₃, TiO₂, BaSO₄, clay, magnesium-aluminium silicate, styrene-acrylic copolymers and combinations thereof.

8. The pigment coated paper base according to claim 6, wherein the binder is selected from the group consisting of a styrene-butadiene latex, methyl methacrylate-butadiene latex, polyacrylate latex, styrene-acrylic resins, polyvinyl alcohol, polysaccharide, starch and combinations thereof.

9. The pigment coated paper base according to claim 1, in which the pigmented coating is used in an amount from 0.5 to 40 g/m².

10. The pigment coated paper base according to claim 1, wherein the epoxidized fatty acid amide is a condensation product of one or more of stearic acid, oleic acid, lauric acid, palmitic acid, arachic acid, behenic acid, tall oil fatty acid, alkylsuccinic acid, alkenyl succinic acid, a polyamine or epichrolohydrin.

11. The pigment coated paper base according to claim 1, wherein the alkyl ketene dimer includes an alkyl residue having higher fatty acids containing 8 to 30 carbon atoms.

12. The pigment coated paper base according to claim 10, wherein the epoxidized fatty acid is a condensation product comprising behenic acid and/or wherein the alkyl ketene dimer comprises a behenic acid group.

13. The pigment coated paper base according to claim 10, wherein the epoxidized fatty acid is a condensation product comprising behenic acid and diethylenetriamine/triethylenetetramine and epichlorohydrin or mixtures thereof.

14. A printing paper comprising the pigment coated paper base of claim 1 and a polymer resin on a top side of the printing paper.

15. A printing paper comprising the pigment coated paper base of claim 1 including a polymer resin layer on the top and the back sides of the printing paper.

16. The printing paper of claim 14, wherein the top polymer resin comprises a pigment.

17. The printing paper of claim 16, wherein the pigment is selected from the group consisting of CaCO₃, TiO₂, BaSO₄, clay, and magnesium-aluminium silicate.

18. The printing paper of claim 14, wherein said polymer resin is used in an amount from 5 to 60 g/m2.

19. The printing paper of claim 14, having a thickness of from 60 to 360 micrometer.

20. The printing paper according to claim 14, wherein the polymer resin is selected from the group consisting of polyethylene resin, polypropylene resin and polymethyl-methacrylate resin and combinations thereof.

21. The printing paper according to claim 20, wherein the polymer resin is a polyethylene resin.

22. The printing paper according to claim 13, wherein the polymer coating has been applied using melt extrusion coating with a speed of at least 200 m/min.

23. A process for producing a pigment coated paper base, comprising providing a paper base using epoxidized fatty acid amide as a sizing agent, having a top side and a back side and applying a pigmented coating dispersion, containing pigments and a binder, to at least the top side of said base.

24. The process according to claim 23 in which the pigment coated paper base is provided with, at least on the top side, a pigmented polymer resin applied through melt extrusion coating.

25. The process according to claim 24, wherein the polymer resin coating is applied at a paper speed of at least 200.

26. Use of the pigment coated paper base of claim 1 in a printing application.

27. Use of the printing paper of claim 14 in a printing application.

28. Use of a combination of an alkyl ketene dimer and an epoxidized fatty acid amide as a sizing agent in a pigment coated paper base for improvement of the edge penetration behavior of said pigment coated paper base.

29. The pigment coated paper base according to claim 1, wherein the average surface roughness R_{A} is less than 0.8 μm.

30. The pigment coated paper base according to claim 1, in which the pigment coating is used in an amount from 1 to 20 g/m².

31. The printing paper according to claim 13, wherein the polymer coating has been applied using melt extrusion coating with a speed of over 300 m/min.

32. The process according to claim 24, wherein the polymer resin coating is applied at a paper speed of more than 300 m/min.

33. Use of the pigment coated paper base manufactured according to claim 23 in a printing application.

34. Use of the printing paper manufactured according to claim 24 in a printing application.
